(19) United States
(12) Patent Application Publication
(10) Pub. No.: US 2020/0274124 A1
(43) Pub. Date: Aug. 27, 2020

(54) SIC SEPARATOR AND SIC CELL

(71) Applicant: Robert Bosch GmbH, Stuttgart (DE)

(72) Inventors: Joerg Thielen, Stuttgart (DE); Frank Baumann, Hayward, CA (US); Ulrich Sauter, Karlsruhe (DE)

(21) Appl. No.: 15/780,997

(22) PCT Filed: Nov. 24, 2016
(86) PCT No.: PCT/EP2016/078627

§ 371 Date: Jun. 1, 2018

(30) Foreign Application Priority Data
Dec. 4, 2015 (DE) 10 2015 224 345.1

(51) Int. Cl. H01M 2/16; C08F 12/20; C08F 12/30; H01M 10/0525; H01M 4/38; C08F 220/28

(52) U.S. Cl. CPC H01M 2/166; C08F 12/20; C08F 220/286; H01M 10/0525; H01M 4/382; C08F 12/30

(57) ABSTRACT

A separator and/or protective layer for a lithium cell. In order to enable rapid charging of the cell and to extend the service life of the cell, the separator and/or the protective layer encompasses a copolymer and/or a polymer blend, the copolymer encompassing at least one repeating unit for constituting a polymer having a lithium-ion transference number >0.7 and at least one mechanically stabilizing repeating unit, and/or the polymer blend encompassing at least one polymer having a lithium-ion transference number >0.7 and at least one mechanically stabilizing polymer. Cells, and copolymers, polymer blends, and polymer electrolytes on the basis of polymers having a lithium-ion transference number >0.7, are also described.

### FIELD

The present invention relates to a separator and/or protective layer for a lithium cell and to such cells, and to copolymers, polymer blends, and polymer electrolytes therefor.

### BACKGROUND INFORMATION

Lithium battery cells encompass a cathode, an anode, and a separator. The cathode and the anode are electrically conductively connectable to one another via an external electrical circuit, in particular via current collectors, in order to discharge and deliver electrical current. The electrical circuit is closed in the cell, in particular between the cathode and anode, via at least one electrolyte.

Liquid electrolytes, made of a liquid solvent in which a conducting salt is dissolved, are usually used.

Many battery cells have, instead of a liquid electrolyte, a polymer electrolyte based on a polymer having a conducting salt dissolved therein. In order to increase conductivity, a liquid solvent can be mixed into polymer electrolytes, with the result that a polymer gel electrolyte can be formed.

Anodes made of metallic lithium tend to form dendrites in particular when liquid electrolytes or polymer gel electrolytes, and/or polymer electrolytes having insufficient mechanical stability, are used.

European Patent No. EP 1098382 relates to a polyelectrolyte gel for an electrochemical apparatus.

U.S. Patent Application No. US 2006/0177732 relates to battery electrodes and to methods for manufacturing alkali metal electrodes having a reinforced glass-like protective layer.

### SUMMARY

The present invention relates to a separator and/or a protective layer for a lithium cell, for example for a lithium-ion cell or a lithium-sulfur cell, in particular in the form of a solid-state cell, which encompasses a copolymer and/or a polymer blend.

The copolymer encompasses in particular at least one repeating unit for constituting a polymer having a lithium-ion transference number >0.7 and at least one mechanically stabilizing repeating unit, and/or the polymer blend encompasses at least one polymer having a lithium-ion transference number >0.7 and at least one mechanically stabilizing repeating unit.

The separator and/or the protective layer can be, for instance, (only) a separator or a separator having a protective-layer function for an anode or cathode, in particular to prevent dendrite growth, for instance for a lithium metal anode, or a protective layer for an anode or cathode, in particular to prevent dendrite growth, for instance for a lithium metal anode.

A “mechanically stabilizing repeating unit” can be understood in particular as a repeating unit that encompasses rigid groups, in particular aromatic groups. For example, the mechanically stabilizing repeating unit can be an aromatic group. For instance, the mechanically stabilizing repeating unit can be a styrene- and/or phenylene-based unit. The at least one mechanically stabilizing repeating unit can be designed in particular to constitute a mechanically stabilizing polymer.

A “mechanically stabilizing polymer” can be understood in particular as a polymer that encompasses rigid groups, in particular aromatic groups. For example, the mechanically stabilizing polymer can be a polymer having aromatic groups. For instance, the mechanically stabilizing polymer can be a styrene- and/or phenylene-based polymer, for example a polystyrene and/or polyphenylene.

By way of the at least one repeating unit for constituting a polymer having a lithium-ion transference number >0.7, or the at least one polymer having a lithium-ion transference number >0.7, extreme concentration gradients that occur upon application of high current densities over longer periods of time in conventional liquid electrolytes, for instance a solution of the conducting salt lithium bis(trifluoromethanesulfonyl)imide (LiTFSI) in a mixture of ethylene carbonate (EC), dimethyl carbonate (DMC), and/or diethyl carbonate (DEC), which typically have transference numbers of only 0.5, and in conventional polymer electrolytes, for instance a mixture of polyethylene oxide and the conducting salt lithium bis(trifluoromethanesulfonyl)imide (LiTFSI), which typically have transference numbers of only approximately 0.25, and can result in large overvoltages that can limit the achievable current densities, can be at least minimized or avoided. Minimization or avoidance of extreme concentration gradients makes it possible, in particular, on the one hand to avoid regional depletion of conducting salt, which can result in a great decrease in electrochemical kinetics and thus can lead to an increase in kinetic overvoltages and to a preference for undesired electrochemical secondary reactions and, in some cases, even to cell damage. On the other hand, it is thereby possible in particular to prevent conducting salt from precipitating in regions of very high salt concentration, which can result in blockage of pores and, if applicable, even in a reduction in local conductivity by several orders of magnitude.

It is thus advantageously possible to maintain high current densities even over long periods of time and large Δ-SOC ranges, in particular for a constant high current load, for instance 3C or higher, in the charging and discharging direction, and in particular also to achieve rapid charging of the cell.

Thanks to the at least one mechanically stabilizing repeating unit or the at least one mechanically stabilizing polymer it is moreover possible to achieve high lithium dendrite resistance in particular for the separator and/or the protective layer, which can have an advantageous effect on the service life of a cell equipped therewith, for example having a lithium metal anode.

In addition to an increase in mechanical stability, mechanically stabilizing units or polymers, in particular styrene-based units or polymers, in particular in the copolymer, can if applicable advantageously improve the solubility of the block copolymer as compared with an exclusively single-ion-conducting polymer/homopolymer. The production and application of a thin film onto a cathode and/or anode can thereby be simplified.

All in all, utilization of the copolymer and/or polymer blend or of the separator based thereon and/or of the protective layer based thereon allows the provision in a simple manner of, in particular solid electrolyte-based, lithium cells which can be charged and discharged quickly and which can exhibit a long service life and, in particular, can also be used in electric vehicles.

In the context of an example embodiment, the at least one mechanically stabilizing repeating unit encompasses or is at least one styrene-based unit, and/or the at least one mechanically stabilizing polymer encompasses or is at least one styrene-based polymer.

A “styrene-based repeating unit” can be, for example, styrene and/or styrene derivatives that are derivable, for example, by single or multiple substitution and/or functionalization of styrene.

A “styrene-based polymer” can be understood in particular as a polymer that is obtainable by polymerization of styrene and/or of styrene derivatives, which are derivable for example by single or multiple substitution of styrene.

For instance, the at least one styrene-based repeating unit and/or the at least one styrene-based polymer can be obtainable by polymerization of styrene and/or o-methylstyrene and/or p-methylstyrene and/or m-t-butoxystyrene and/or 2,4-dimethylstyrene and/or m-chlorostyrene and/or p-chlorostyrene and/or 4-carboxystyrene and/or vinylanisole, and/or vinylbenzoic acid and/or vinylaniline and/or vinylnaphthalene.

The at least one repeating unit for constituting a polymer having a lithium-ion transference number >0.7 and/or the at least one polymer having a lithium-ion transference number >0.7 can in particular have a lithium-ion transference number >0.8.

For instance, the at least one repeating unit for constituting a polymer having a lithium-ion transference number >0.7, in particular >0.8, can encompass or be a borate-based unit and/or a sulfonic acid-based unit and/or an imide-based, in particular sulfonylimide-based, unit, and or a unit on the basis of lithiated acrylic acid and/or methacrylic acid and/or a perfluoroether-based unit. Polymers constituted from such units can advantageously have transference numbers >0.8.

Alternatively or in addition thereto, the at least one polymer having a lithium-ion transference number >0.7, in particular >0.8, can encompass or be a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid and/or a perfluoropolyether-based polymer. Such polymers can advantageously have transference numbers >0.8.

In particular, the at least one repeating unit for constituting a polymer having a lithium-ion transference number >0.7 and/or the at least one polymer having a lithium-ion transference number >0.7 can have a lithium-ion transference number >0.9.

Single-ion-conducting polyelectrolytes can advantageously have lithium-ion transference numbers >0.9, which in particular can in fact be close to 1.

In the context of a further example embodiment, the at least one repeating unit for constituting a polymer having a lithium-ion transference number >0.7, in particular >0.9, is designed to constitute a single-ion-conducting polyelectrolyte, and/or the at least one polymer having a lithium-ion transference number >0.7, in particular >0.9, encompasses or is a single-ion-conducting polyelectrolyte.

A “single-ion-conducting” polyelectrolyte, or single-ion conductor (SIC), can be understood in particular as an electrolyte, in particular a polymer or polymer electrolyte, in which anions are attached fixedly, in particular covalently, onto a polymer backbone and/or integrated, in particular directly, into a polymer backbone or into a polymer framework, and thereby only the corresponding cations, in particular lithium ions, are mobile or movable. Only the ion species, namely the lithium ions, that in fact participates in the electrochemical electrode reaction is therefore mobile.

Single-ion-conducting polyelectrolytes are notable for transference numbers for lithium ions (Li⁺) which are close to 1. Extreme concentration gradients can therefore be avoided, and particularly high current densities achieved, using single-ion-conducting polyelectrolytes.

In particular, the copolymer can encompass at least one repeating unit for constituting a single-ion-conducting polyelectrolyte and at least one styrene-based repeating unit, and/or the polymer blend can encompass at least one single-ion-conducting polyelectrolyte and at least one styrene-based polymer.

A repeating unit for constituting a single-ion-conducting polyelectrolyte can encompass, for example, a negatively charged group Q⁻, or an anion, that is bound, for example attached, fixedly, in particular covalently, to, or integrated into, the polymer backbone, and a mobile positively charged counter ion, in particular lithium ion.

A single-ion-conducting polyelectrolyte can in particular encompass a negatively charged group Q⁻, or an anion, that is bound, for example attached, fixedly, in particular covalently, to, or integrated into, a unit forming a polymer backbone, and a mobile positively charged counter ion, in particular lithium ion.

In the context of a further embodiment, the at least one repeating unit for constituting a polymer having a lithium-ion transference number >0.7, in particular >0.9, or the at least one repeating unit for constituting a single-ion-conducting polyelectrolyte, encompasses or is a borate-based unit and/or a sulfonic acid-based unit and/or an imide-based, in particular sulfonylimide-based, unit, and/or a unit on the basis of lithiated acrylic acid and/or methacrylic acid, and/or the at least one polymer having a lithium-ion transference number >0.7, in particular >0.9, or the at least one single-ion-conducting polyelectrolyte, encompasses or is a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid.

Some examples of such units or polymers which can exhibit transfer numbers >0.8 will be explained below.

Borate-based single-ion-conducting polyelectrolytes can be embodied, for example, in the form of an anionic borate network (borate anion network). The borate anion network can be constituted by borate anions that are incorporated via at least one linker, for instance tartaric acid. An example of a borate-based polyelectrolyte of this kind, having the general chemical formula

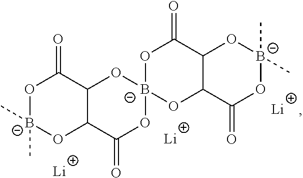

[symbol]

is described in Solid State Ionics 262, 2014, pp. 747-753.

Borate-based polyelectrolytes can, however, also be embodied, for example, in the form of polymers having borate groups attached, in particular covalently, to the polymer backbone of the polymer. An example of such a borate-based polyelectrolyte, which is constituted from monomers of the general chemical formula

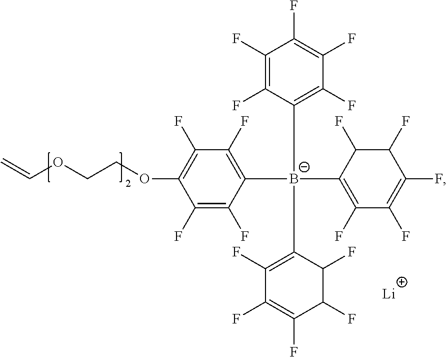

[symbol]

is described in Polym. Chem., 2015, 6, p. 1052. These polyelectrolytes usually achieve sufficient conductivity, however, only in the form of a gel having a liquid component.

In the context of a special embodiment of the present invention, the at least one repeating unit for constituting a polymer having a lithium-ion transference number >0.7, in particular >0.9, encompasses or is a borate-based unit of the general chemical formula

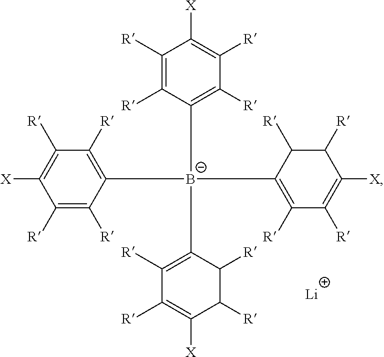

[symbol]

where at least one X, in particular at least two X, for example three X or four X, denote

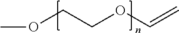

where 2≤n≤10, in particular 3≤n≤10, where the remaining X, mutually independently in each case, denote

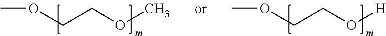

or R′, where 2≤m≤10, in particular 3≤m≤10, and where R′ denotes hydrogen or fluorine. By way of at least two bonds it is thus advantageously possible to constitute a network and thereby to improve mechanical stability and thus lithium dendrite resistance. A lengthening of the linker and/or introduction of further ethylene oxide groups thus advantageously allows lithium-ion conductivity to be improved even without adding liquid components.

Examples of sulfonic acid-based polyelectrolytes are lithium Nafion, for instance of the general chemical formula

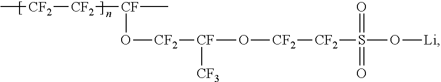

and/or comparable sulfonic acid-based polymers, such as the sulfonic acid-based polyelectrolytes of the general chemical formula

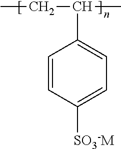

described by Zhibin Zhou et al. in Electrochimica Acta, 93, 2013, pp. 254-263.

Imide-based, in particular sulfonylimide-based, polyelectrolytes can be based, for instance, on poly(perfluoroalkylsulfony)imide. Imide-based, in particular sulfonylimide-based, polyelectrolytes of the general chemical formula

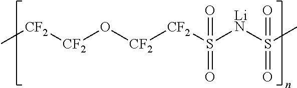

are described in J. Mater. Chem. A., 2014, 2, 15952. Imide-based, in particular sulfonylimide-based, polyelectrolytes can also be based, for instance, on (4-styrenesulfonyl) (trifluoromethanesulfonylimide) monomers. Examples thereof are homopolymers or copolymers of the general chemical formula

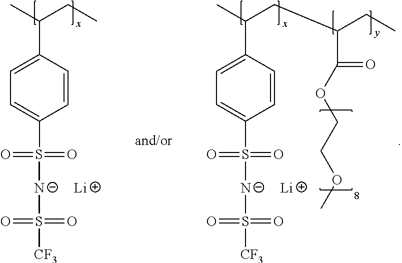

Examples of polyelectrolytes based on lithiated acrylic acid and/or methacrylic acid are, for instance, poly-MMALi or related polyelectrolytes.

Examples of perfluoroether-based polymers of the general chemical formulas

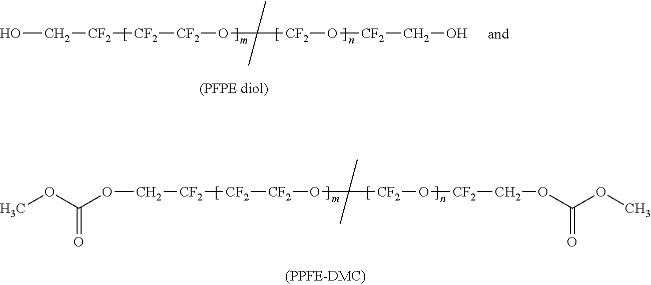

[symbol]

are described in Proceedings of the National Academy of Sciences, 111, 2014, p. 3327. Perfluoropolyether-based polymers of this kind, in contrast to the other polyelectrolytes described above, are usually not single-ion-conducting polyelectrolytes but instead are lithium-ion-conductive polymers that have neither fixedly attached anions nor mobile cations, and become lithium ion-conducting only by addition of a lithium conducting salt such as lithium bis(trifluoromethanesulfonyl)imide (LiTFSI). They can nevertheless have high transference numbers. This could be based on the fact that as a result of fluorination, the electron density at the perfluoropolyether oxygen is lowered and thus coordination between the oxygen and lithium ion is weakened, and lithium cation dynamics are elevated, such that at the same time the fluorinated salt anion interacts very strongly with the perfluoropolyether and its mobility is lowered, and the value of the transference number is thus positively influenced. If the electrolyte of the cathode (catholyte) and/or of the anode (anolyte) is based only on single-ion-conducting polyelectrolytes and/or inorganic single-ion conductors that do not require the addition of lithium conducting salt, the copolymer and/or the polymer blend is preferably free of such perfluoropolyether-based units or polymers, in order to avoid depletion of the perfluoropolyether-based units or polymers and thus of the separator due to solution and diffusion of the salts into the cathode or anode.

For instance, the at least one repeating unit for constituting a polymer having a lithium-ion transference number >0.7, in particular >0.9, or the at least one repeating unit for constituting a single-ion-conducting polyelectrolyte, can encompass or be
a borate-based unit of the general chemical formulas

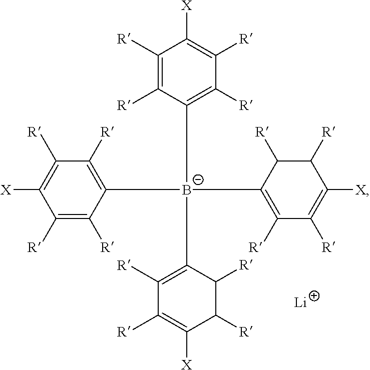

where at least one X, in particular at least two X, for example three X or four X, denote

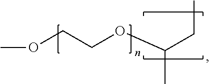

where 2≤n≤10, in particular 3≤n≤10,
the remaining X denoting, mutually independently in each case,

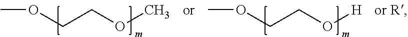

where 2≤m≤10, in particular 3≤m≤10, and where R′ denotes hydrogen or fluorine; and/or
an imide-based, in particular sulfonylimide-based, unit of the general chemical formula

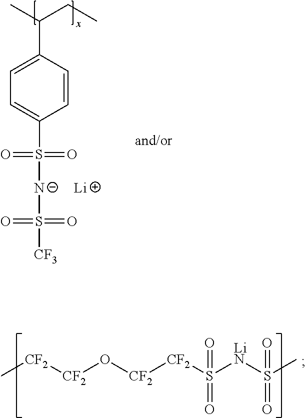

and/or
a sulfonic acid-based unit of the general chemical formula

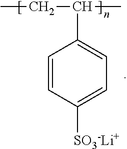

The at least one repeating unit for constituting a polymer having a lithium-ion transference number >0.7 and/or the at least one polymer having a lithium-ion transference number >0.7 can be obtainable in particular by polymerization of at least one double bond. For instance, the borate-based unit and/or the sulfonic acid-based unit and/or the imide-based, in particular sulfonylimide-based, unit and/or the unit on the basis of lithiated acrylic acid and/or methacrylic acid and/or the perfluoroether-based unit, and/or the borate-based polyelectrolyte and/or the sulfonic acid-based polyelectrolyte and/or the imide-based, in particular sulfonylimide-based, polyelectrolyte and/or the polyelectrolyte on the basis of lithiated acrylic acid and/or methacrylic acid and/or the perfluoroether-based polymer, can be obtainable by polymerization of at least one double bond. Such units or polymers can advantageously be respectively copolymerized by conventional copolymerization with styrene, in particular so as thereby to obtain in simple fashion a mechanically stabilized copolymer for utilization as a separator and/or protective layer.

For instance, the copolymer can be manufactured by copolymerization of styrene and/or of a styrene derivative, for example o-methylstyrene and/or p-methylstyrene and/or m-t-butoxystyrene and/or 2,4-dimethylstyrene and/or m-chlorostyrene and/or p-chlorostyrene and/or 4-carboxystyrene and/or vinylanisole, and/or vinylbenzoic acid and/or vinylaniline and/or vinylnaphthalene, with a monomer of the general chemical formula

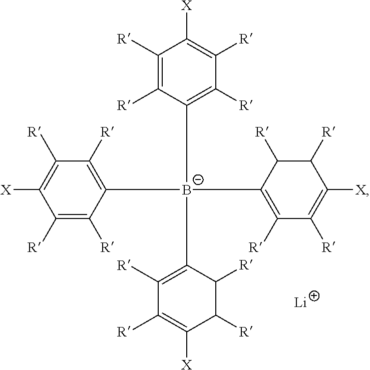

where at least one X, in particular at least two X, for example three X or four X, denote

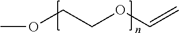

where 2≤n≤10, in particular 3≤n≤10, the remaining X, mutually independently in each case, denoting

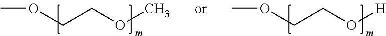

or R′, where 2≤m≤10, in particular 3≤m≤10, and where R′ denotes hydrogen or fluorine, and/or
with a monomer of the general chemical formula

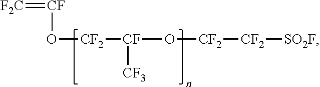

in particular by hydrolysis to the sulfonic acid with subsequent lithiation, and/or
with a monomer of the general chemical formula

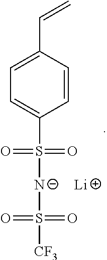 [SMILES: C=Cc1ccc(S(=O)(=O)[N-]S(=O)(=O)C(F)(F)F)cc1 ; [Li+]]

In the context of a further embodiment, the copolymer is a block copolymer. The block copolymer can in particular encompass at least one, in particular single-ion-conducting, block (b-A) made of at least one repeating unit for constituting a polymer having a lithium-ion transference number >0.7 (A), and at least one, in particular mechanically stabilizing, block (b-B) made of at least one mechanically stabilizing repeating unit (B).

In particular, the block copolymer (b-SIC-b-PS) can encompass at least one, in particular single-ion-conducting, block (b-SIC) made of at least one repeating unit for constituting a single-ion-conducting polyelectrolyte (SIC) and at least one, in particular mechanically stabilizing, block (b-PS) made of at least one styrene-based repeating unit (PS).

The, in particular single-ion-conducting, block (b-A) can be both a homopolymer made of a repeating unit for constituting a polymer having a lithium-ion transference number >0.7 (A), in particular a single-ion-conducting polyelectrolyte, and a statistical copolymer made of several different repeating units for constituting a polymer having a lithium-ion transference number >0.7 (A), in particular a single-ion-conducting polyelectrolyte.

The, in particular mechanically stabilizing, block (b-B) can also be both a homopolymer made of a mechanically stabilizing, in particular styrene-based, repeating unit (B) and a statistical copolymer made of several different mechanically stabilizing, in particular styrene-based, repeating unit (B).

In addition to a di-block copolymer (b-A-b-B), tri-block copolymers (b-A-b-B-b-A or b-B-b-A-b-B, such as b-PS-b-SIC-b-PS) and multi-block copolymers are, for example, also possible.

In the context of a further embodiment, the copolymer additionally encompasses at least one lithium-ion-conductive repeating unit, and/or the polymer blend additionally encompasses at least one lithium-ion-conductive polymer.

The mobility of the lithium ions in the system, and thus the conductivity, can thereby advantageously be increased while the transference number remains high (close to 1). This can be advantageous in particular with borate-based units or polyelectrolytes, and/or with imide-based units or polyelectrolytes.

A “lithium-ion-conductive” material, for example a lithium-ion-conductive repeating unit or a lithium-ion-conductive polymer, can be understood in particular as a material, for example a repeating unit or a polymer, that itself can be free of the ions to be conducted, for instance lithium ions, but is itself designed to coordinate and/or solvate the ions to be conducted, for instance lithium ions, and/or to coordinate counter ions of the ions to be conducted, for instance lithium conducting salt anions, and becomes lithium ion-conducting, for example, upon addition of the ions to be conducted, for instance lithium ions, in particular in the form of a single-ion-conducting polyelectrolyte and/or if applicable in the form of a conducting salt.

In the context of a further embodiment, the at least one lithium-ion-conductive repeating unit encompasses or is an alkylene oxide unit, for example an ethylene oxide unit (EO) and/or a propylene oxide unit (PO), in particular an ethylene oxide unit (EO), and/or an oligoethylene glycol methacrylate unit (OEGMA) and/or an oligoethylene glycol acrylate unit, in particular an oligoethylene glycol methacrylate unit (OEGMA), and/or the at least one lithium-ion-conductive polymer encompasses or is a polyalkylene oxide, for example polyethylene oxide and/or polypropylene oxide, in particular polyethylene oxide, and/or poly(oligoethylene glycol) methacrylate (POEGMA) and/or poly(oligoethylene glycol) acrylate, in particular poly(oligoethylene glycol) methacrylate (POEGMA).

The at least one lithium-ion-conductive repeating unit can be integrated into the copolymer, in particular block copolymer, for example via a block copolymerization or also as a statistical copolymerization.

For instance, the block copolymer can furthermore encompass at least one, in particular lithium-ion-conductive, block (b-C, for example b-OEGMA/EO/PO) made of at least one lithium-ion-conductive repeating unit (C, for example OEGMA/EO/PO).

Integration of the at least one, in particular lithium-ion-conductive, block can proceed, for example, from a terminal hydroxide group (OH group) of the at least one, in particular lithium-ion-conductive block, which group is reacted, for instance, with acryloyl chloride or a-bromoisobutyryl bromide, which can be followed by radical polymerization by which the at least one, in particular mechanically stabilizing, block made of at least one mechanically stabilizing, in particular styrene-based, repeating unit and/or the at least one, in particular single-ion-conducting, block made of at least one repeating unit is linked in order to constitute a polymer having a lithium-ion transference number >0.7, in particular a single-ion-conducting polyelectrolyte. For instance, integration of the at least one, in particular lithium-ion-conductive, block can proceed from a terminal hydroxide group (OH group) of the at least one, in particular lithium-ion-conductive, block, which group is reacted with a-bromoisobutyryl bromide, which can be followed by atom transfer radical polymerization (ATRP) by way of which the at least one, in particular mechanically stabilizing, block made of at least one mechanically stabilizing, in particular styrene-based, repeating unit and/or the at least one, in particular single-ion-conducting, block made of at least one repeating unit is linked in order to constitute a polymer having a lithium-ion transference number >0.7, in particular a single-ion-conducting polyelectrolyte. In particular, integration of perfluoropolyether-based polymers can also be achieved by way of such a reaction with acid chlorides.

In the context of a further embodiment, the block copolymer is a di-block copolymer (b-A-b-B, for example b-SIC-b-PS) or a tri-block copolymer (b-A-b-B-b-A or b-B-b-A-b-B or b-A-b-B-b-C, for example b-SIC-b-PS-b-SIC or b-PS-b-SIC-b-PS or b-A-b-B-b-OEGMA/EO/PO) or a multi-block copolymer (b-A-b-C-b-B-b-C-b-A or b-B-b-C-b-A-b-C-b-B, for example b-SIC-b-OEGMA/EO/PO-b-PS-b-OEGMA/EO/PO-b-SIC or b-PS-B-EGMA/EGA/EO/PO-b-SIC-b-OEGMA/EO/PO-b-B.

With block copolymers, if applicable (for example when a polymer layer is cast from a solution), lamellar self-assembly can occur; this can result in improved properties for the separator and/or the protective layer.

In order to optimize mechanical stability and/or transport properties, the aforementioned (co)polymers and block copolymers can also, for example, additionally be mixed with one another (blends). For example, polymer blends made of at least one polymer having a lithium-ion transference number >0.7, in particular at least one single-ion-conducting polyelectrolyte, and at least one mechanically stabilizing, in particular styrene-based, polymer, as well as optionally at least one lithium-ion-conductive polymer, for example also without block copolymerization, can also, for example, yield a separator layer that can exhibit sufficient lithium ion transport properties and sufficient mechanical stability. In general, however, better assembling of the conducting and stabilizing units can be achieved, and better lithium ion transport properties thereby achieved, by way of copolymers, in particular block copolymers.

In order to further increase mechanical stability and lithium dendrite resistance, for instance a blend of a copolymer, in particular block copolymer, with at least one further mechanically stabilizing polymer, can be used.

In order to further improve lithium ion transport properties, for instance a blend of a copolymer, in particular block copolymer, with at least one further polymer having a lithium-ion transference number >0.7 and/or with at least one further lithium-ion-conductive polymer, can be used.

In order to improve binding properties, for instance a blend of a copolymer, in particular block copolymer, and at least one binder based on polyvinylidene fluoride (PVDF) can be used.

Blends of various block copolymers with other block copolymers, for instance b-A-b-B with b-A-b-B′, b-A-b-B-b-A with b-A-b-B-b-A′, b-B-b-A-b-B with b-B-b-A-b-B′ or b-A-b-B-b-C with b-A-b-B-b-C′, b-A-b-B-b-C with b-A-b-B-b-A, b-A-b-B-b-C with b-B-b-A-b-B, are also possible.

For additional optimization of the mechanical stability and/or transport properties of the separator and/or the protective layer, the separator and/or the protective layer can furthermore encompass at least one, in particular ceramic and/or glass-like, inorganic ion conductor, in particular single-ion conductor, and/or at least one further additive, for example at least one filler, for instance silicon dioxide (SiO₂), titanium dioxide (TiO₂), or aluminum oxide (Al₂O₃).

In the context of a further embodiment, the separator and/or the protective layer therefore furthermore encompasses at least one, in particular ceramic and/or glass-like, inorganic ion conductor, in particular single-ion conductor. For example, the at least one, in particular ceramic and/or glass-like, inorganic ion conductor, in particular single-ion conductor, can have a lithium-ion transference number >0.7, for example >0.8, for instance >0.9.

An “inorganic single-ion conductor” can be understood in particular as an inorganic electrolyte in which anions are attached fixedly, in particular ionically, onto a structure, for example a crystal lattice, and/or are integrated, in particular directly, into a structure, for example a crystal lattice, and as a result only the corresponding cations, in particular lithium ions, are mobile or movable. It is thus only the ion species that in fact participate in the electrochemical electrode reaction, namely the lithium ions, that are mobile.

Inorganic single-ion conductors are likewise notable for transference numbers for lithium ions (Li⁺) which are close to 1. Extreme concentration gradients can thereby also be avoided, and high current densities achieved, using inorganic single-ion conductors.

For instance, the at least one, in particular ceramic and/or glass-like, inorganic ion conductor, in particular single-ion conductor, can encompass or be at least one sulfidic ion conductor, in particular single-ion conductor. The at least one inorganic, in particular sulfidic, ion conductor can, for example, be glass-like. For instance, the at least one inorganic, in particular sulfidic, ion conductor can be based on the general chemical formula (Li₂S)ₓ:(P₂S₅)_{y}:D_{z}, where D_{z} denotes one or more additives, for example LiCl and/or LiBr and/or LiI and/or LiF and/or Li₂Se and/or Li₂O and/or P₂Se₅ and/or P₂O₅ and/or Li₃PO₄ and/or one or more sulfides of germanium, boron, aluminum, molybdenum, tungsten, silicon, arsenic, and/or niobium, in particular germanium. In particular x, y, and z can denote component ratios. Ion conductors of this kind can be synthesized, for example, from the individual components Li₂S and P₂S₅ and if applicable D. The synthesis can be carried out, where applicable, under inert gas.

In particular, the at least one, in particular ceramic and/or glass-like, inorganic ion conductor, in particular single-ion conductor, can encompass or be a lithium argyrodite and/or a sulfidic glass.

These single-ion conductors have proven to be particularly advantageous because they can exhibit high ionic conductivity and low contact resistance values at the grain boundaries within the material and with further components, for instance with the cathode active material. In addition, these ion conductors can be ductile, and for that reason can be used particularly advantageously with porous active materials that, for example, can also have a rough surface. All in all, the long-term stability and performance of a cell equipped with the cathode material can thereby advantageously be further improved.

“Lithium argyrodites” can be understood in particular as compounds that derive from the mineral argyrodite having the general chemical formula Ag₈GeS₆, where silver (Ag) is replaced by lithium (Li) and where in particular germanium (Ge) and/or sulfur (S) can also be replaced by other elements, for instance of the main groups III, IV, V, VI, and/or VII.

Examples of lithium argyrodites are:
compounds of the general chemical formula

Li₇PCh₆

where Ch denotes sulfur (S) and/or oxygen (O) and/or selenium (Se), for example sulfur (S) and/or selenium (Se), in particular sulfur (S);
compounds of the general chemical formula

Li₆PCh₅X
where Ch denotes sulfur (S) and/or oxygen (O) and/or selenium (Se), for example sulfur (S) and/or oxygen (O), in particular sulfur (S), and X denotes chlorine (Cl) and/or bromine (Br) and/or iodine (I) and/or fluorine (F), for example X denotes chlorine (Cl) and/or bromine (Br) and/or iodine (I);
compounds of the general chemical formula

Li_{7-δ}PCh_{6-δ}X_{δ}
where Ch denotes sulfur (S) and/or oxygen (O) and/or selenium (Se), for example sulfur (S) and/or selenium (Se), in particular sulfur (S), B denotes phosphorus (P) and/or arsenic (As), X denotes chlorine (Cl) and/or bromine (Br) and/or iodine (I) and/or fluorine (F), for example X denotes chlorine (Cl) and/or bromine (Br) and/or iodine (I), and 0≤δ≤1.

For instance, the at least one inorganic ion conductor can encompass at least one lithium argyrodite of the chemical formulas Li₇PS₆, Li₇PSe₆, Li₆PS₅Cl, Li₆PS₅Br, Li₆PS₅I, Li_{7-δ}PS_{6-δ}Cl_{δ}, Li_{7-δ}PS_{6-δ}Br_{δ}, Li_{7-δ}PS_{6-δ}I_{δ}, Li_{7-δ}PS_{6-δ}Cl_{δ}, Li_{7-δ}PSe_{6-δ}Br_{δ}, Li_{7-δ}PSe_{6-δ}I_{δ}, Li_{7-δ—AsS}_{6-δ}Br_{δ}, Li_{7-δ}AsS_{6-δ}I_{δ}, Li₆AsS₅I, Li₆AsSe₅I, Li₆PO₅Cl, Li₆PO₅Br, and/or Li₆PO₅I. Lithium argyrodites are described, for example, in the documents Angew. Chem. Int. Ed., 2008, 47, 755-758; Z. Anorg. Allg. Chem., 2010, 636, 1920-1924; Chem. Eur. J., 2010, 16, 2198-2206; Chem. Eur. J., 2010, 16, 5138-5147; Chem. Eur. J., 2010, 16, 8347-8354; Solid State Ionics, 2012, 221, 1-5; Z. Anorg. Allg. Chem., 2011, 637, 1287-1294; and Solid State Ionics, 2013, 243, 45-48.

The lithium argyrodite can in particular be a sulfidic lithium argyrodite, for instance in which Ch denotes sulfur (S).

Lithium argyrodites can be manufactured in particular by way of a mechanical/chemical reaction process, in which for instance starting materials such as lithium halides, for example LiCl, LiBr, and/or LiI, and/or lithium chalcogenides, for example Li₂S and/or Li₂Se and/or Li₂O, and/or chalcogenides of main group V, for example P₂S₅, P₂Se₅, Li₃PO₄, in particular in stoichiometric quantities, are milled together with one another. This can be accomplished, for example, in a ball mill, in particular a high-energy ball mill, for instance at a rotation speed of 600 rpm. Milling can be accomplished in particular in an inert gas atmosphere.

For instance, the at least one inorganic ion conductor can encompass at least one sulfidic glass of the chemical formula Li₁₀GeP₂S₁₂, Li₂S—(GeS₂)—P₂S₅, and/or Li₂S—P₂S₅. For example, the at least one inorganic ion conductor can encompass a germanium-containing sulfidic glass, for instance Li₁₀GeP₂S₁₂ and/or Li₂S—(GeS₂)—P₂S₅, in particular Li₁₀GeP₂S₁₂. Germanium-containing sulfidic lithium ion conductors can advantageously exhibit high lithium ion conductivity and chemical stability.

In the context of a special embodiment, the at least one inorganic ion conductor encompasses or is a lithium argyrodite. Lithium argyrodites are advantageously notable for particularly low contact resistance values at the grain boundaries within the material and with respect to further components, for example the active material particles. Particularly good ion conduction at and within the grain interfaces can thereby advantageously be achieved. Advantageously, lithium argyrodites can exhibit a low contact resistance between grains even without a sintering process. This advantageously allows the manufacture of the electrode, and of the cell, to be simplified.

With regard to further technical features and advantages of the separator according to the present invention and of the protective layer according to the present invention, reference is herewith explicitly made to the explanations in conjunction with the cells according to the present invention, the copolymer according to the present invention, the polymer blend according to the present invention, and the polymer electrolyte according to the present invention, and to the Figures and the description of the Figures.

A further subject of the present invention is a lithium cell, for example a lithium-ion cell or lithium-sulfur cell, and/or a solid-state cell, which encompasses a separator according to the present invention and/or a protective layer according to the present invention. The cell can encompass a cathode and an anode, the separator and/or the protective layer being disposed between the cathode and the anode. The anode can be, for example, a lithium metal anode, in particular made of metallic lithium.

The separator according to the present invention and/or the protective layer according to the present invention advantageously can additionally take on the function of a barrier for liquid components, for example liquid electrolytes and/or ionic liquids, in the electrolyte of the cathode (catholyte) and/or in the electrolyte of the anode (anolyte), since the separator and/or the protective layer is dissolvable by the latter only to a very small extent, and therefore can also be swollen very little by them.

The cathode, in particular the catholyte, and/or the anode, in particular the anolyte, can therefore have, in combination with a separator according to the present invention, at least one liquid electrolyte, for instance made of at least one solvent, for example at least one organic carbonate, and at least one lithium conductive salt, for example lithium bis(trifluoromethanesulfonyl)imide (LiTFSI), and/or at least one ionic liquid. By way of these liquid components, the conductivity and lithium diffusion of the catholyte or anolyte advantageously can be appreciably increased while the lithium-ion transference number (t+) remains high.

Calculations have indicated that when a separator according to the present invention and/or a protective layer according to the present invention is used, it can be sufficient, if applicable, also to use in the cathode and/or anode an electrolyte, for example respectively a catholyte or anolyte, that has a transference number only ≤0.7, preferably ≥0.5. In combination with the separator according to the present invention, the cathode and/or the anode can therefore also, if applicable, use at least one liquid electrolyte and/or polymer gel electrolyte having at least one lithium salt, for example lithium bis(trifluoromethanesulfonyl)imide (LiTFSI), dissolved therein, having a transference number ≤0.7, preferably ≥0.5.

In the context of an embodiment, however, the cathode, in particular the catholyte, encompasses at least one polymer having a lithium-ion transference number >0.7, in particular >0.8, for example >0.9, and/or at least one, in particular ceramic and/or glass-like, inorganic ion conductor, in particular single-ion conductor, for example having a lithium-ion transference number >0.7, in particular >0.8, for example >0.9, and/or the anode, in particular the anolyte, encompasses at least one polymer having a lithium-ion transference number >0.7, in particular >0.8, for example >0.9, and/or at least one, in particular ceramic and/or glass-like, inorganic ion conductor, in particular single-ion conductor, for example having a lithium-ion transference number >0.7, in particular >0.8, for example >0.9.

With regard to further technical features and advantages of such a cell according to the present invention, reference is herewith explicitly made to the explanations in conjunction with the cell according to the present invention described below.

A further subject of the invention is in fact a lithium cell, for example a lithium-sulfur cell or lithium-ion cell, and/or solid-state cell, encompassing a cathode and an anode, a separator and/or a protective layer being disposed between the cathode and the anode. The separator and/or the protective layer encompasses at least one polymer having a lithium-ion transference number >0.7, in particular >0.8, for example 0.9, and/or at least one, in particular ceramic and/or glass-like, inorganic ion conductor, in particular having a lithium-ion transference number >0.7, in particular >0.8, for example >0.9, for instance a single-ion conductor, the cathode, in particular the catholyte, (likewise) encompassing at least one polymer having a lithium-ion transference number >0.7, in particular >0.8, for example 0.9, and/or at least one, in particular ceramic and/or glass-like, inorganic ion conductor, for example having a lithium-ion transference number >0.7, in particular >0.8, for example >0.9, for instance a single-ion conductor, and/or the anode, in particular the anolyte, (likewise) encompassing at least one polymer having a lithium-ion transference number >0.7, in particular >0.8, for example 0.9, and/or at least one, in particular ceramic and/or glass-like, inorganic ion conductor, for example having a lithium-ion transference number >0.7, in particular >0.8, for example >0.9, for instance a single-ion conductor.

In the context of a further embodiment, the at least one polymer having a lithium-ion transference number >0.7, in particular >0.9, of the separator and/or of the protective layer encompasses or is a single-ion-conducting polyelectrolyte.

In the context of a further, alternative or additional embodiment, the at least one polymer having a lithium-ion transference number >0.7, in particular >0.9, of the separator and/or of the protective layer encompasses or is the cathode of a single-ion-conducting polyelectrolyte.

In the context of a further, alternative or additional embodiment, the at least one polymer having a lithium-ion transference number >0.7, in particular >0.9, of the separator and/or of the protective layer encompasses or is the anode of a single-ion-conducting polyelectrolyte.

As a result of the use, both in the separator and/or the protective layer and in the cathode and/or anode, of at least one polymer having a lithium-ion transference number >0.7, in particular a single-ion-conducting polyelectrolyte, and/or of at least one inorganic ion conductor, in particular a single-ion conductor, in particular instead of a polymer electrolyte on the basis of a lithium-ion-conductive polymer having at least one lithium conducting salt dissolved therein, extreme concentration gradients and accompanying overvoltages which can limit the achievable current density can advantageously be at least minimized or avoided. Minimization or avoidance of extreme concentration gradients makes it possible in particular on the one hand to avoid regional depletion of conducting salt, which can result in a severe diminution in electrochemical kinetics and thus in an increase in kinetic overvoltages, and can lead to a preference for undesired electrochemical secondary reactions and, if applicable, even to cell damage. On the other hand, it is thereby possible in particular to prevent conducting salt from precipitating in regions of very high salt concentration, which can result in blockage of pores and, if applicable, even in a reduction in local conductivity by several orders of magnitude.

It is thus advantageously possible to maintain high current densities even over long periods of time and large Δ-SOC ranges, in particular for a constant high current load, for instance 3C or higher, in the charging and discharging direction, and in particular also to achieve rapid charging of the cell.

In addition to the function of electrically insulating the anode and cathode, the separator can also take on the function of a protective layer for one or both electrodes, for example the anode and/or the cathode, for instance a lithium metal anode, with the result that improved lithium dendrite resistance can be achieved; this can have an advantageous effect on the service life of a cell equipped therewith, for example having a lithium metal anode.

All in all, the utilization of the at least one polymer having a lithium-ion transference number >0.7, in particular of the single-ion-conducting polyelectrolyte, and/or of the at least one inorganic ion conductor, in particular single-ion conductor, for example having a lithium-ion transference number >0.7, both in the separator and/or protective layer and in the cathode and/or anode, can make possible rapid charging and discharging and an extended service life for the cell, and the cell can in particular also be used in electric vehicles.

Single-ion-conducting polyelectrolytes advantageously exhibit greater electrochemical stability compared with the polymer electrolytes usually used, for example based on polyethylene oxide/salt mixtures, which have an electrochemical stability of well under 4 V with respect to lithium metal. This may be relevant in particular for utilization thereof as an electrolyte in the cathode (catholyte), in particular if their entire capacity is to be used, since many known intercalation compounds, such as nickel cobalt aluminum oxide (NCA), nickel cobalt manganese oxide (NCM), high-energy nickel cobalt manganese oxide (HE-NCM), lithium manganese oxide (LMO), and/or high-voltage spinels (HV-LMO), which are used as cathode materials and, because of their properties are predestined for cells having high energy densities or because of the comparatively higher average charge/discharge voltage in comparison to LiS-based cells, which is more advantageous for the battery management system, have potentials >4 V in the delithiated state.

In the context of a further embodiment, the at least one, in particular ceramic and/or glass-like, inorganic single-ion conductor of the separator and/or of the protective layer encompasses or is a lithium argyrodite and/or a sulfidic glass.

In the context of a further, alternative or additional embodiment, the at least one, in particular ceramic and/or glass-like, inorganic single-ion conductor of the cathode encompasses or is a lithium argyrodite and/or a sulfidic glass.

In the context of a further, alternative or additional embodiment, the at least one, in particular ceramic and/or glass-like, inorganic single-ion conductor of the anode encompasses or is a lithium argyrodite and/or a sulfidic glass.

In particular, the separator and/or the protective layer and the cathode can encompass at least one polymer having a lithium-ion transference number >0.7, in particular >0.8, for example >0.9, for instance a single-ion-conducting polyelectrolyte.

For example, the at least one polymer having a lithium-ion transference number >0.7, in particular >0.9, or the at least one single-ion-conducting polyelectrolyte of the separator and/or of the protective layer and/or of the cathode and/or of the anode can encompass a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid and/or a perfluoropolyether-based polymer.

In the context of a further embodiment, the at least one polymer having a lithium-ion transference number >0.7, in particular >0.9, or the at least one single-ion-conducting polyelectrolyte of the separator and/or of the protective layer encompasses or is a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid.

In the context of a further, alternative or additional embodiment, the at least one polymer having a lithium-ion transference number >0.7, in particular >0.9, or the at least one single-ion-conducting polyelectrolyte of the cathode, encompasses or is a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid.

In the context of a further, alternative or additional embodiment, the at least one polymer having a lithium-ion transference number >0.7, in particular >0.9, or the at least one single-ion-conducting polyelectrolyte of the anode, encompasses or is a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid.

In the context of a further embodiment, the separator and/or the protective layer encompasses a blend of at least one polymer having a lithium-ion transference number >0.7, in particular >0.8, for example >0.9, in particular a single-ion-conducting polyelectrolyte, and at least one, in particular ceramic and/or glass-like, inorganic ion conductor, for example having a lithium-ion transference number >0.7, in particular >0.8, for example >0.9, in particular a single-ion conductor, for instance a lithium argyrodite and/or a sulfidic glass.

In the context of a further, alternative or additional embodiment, the cathode encompasses a blend of at least one polymer having a lithium-ion transference number >0.7, in particular >0.8, for example >0.9, in particular a single-ion-conducting polyelectrolyte, and at least one, in particular ceramic and/or glass-like, inorganic ion conductor, for example having a lithium-ion transference number >0.7, in particular >0.8, for example >0.9, in particular a single-ion conductor, for instance a lithium argyrodite and/or a sulfidic glass.

In the context of a further, alternative or additional embodiment, the anode encompasses a blend of at least one polymer having a lithium-ion transference number >0.7, in particular >0.8, for example >0.9, in particular a single-ion-conducting polyelectrolyte, and at least one, in particular ceramic and/or glass-like, inorganic ion conductor, for example having a lithium-ion transference number >0.7, in particular >0.8, for example >0.9, in particular a single-ion conductor, for instance a lithium argyrodite and/or a sulfidic glass.

The advantage of such blends is that as a result of the blending with comparatively soft polymer, in particular a single-ion-conducting polyelectrolyte, the manufacture of a dense cathode having little porosity can be simpler, and/or the contact resistance values can end up being even lower, than in the case of an exclusively inorganic ion conductor, for example lithium argyrodite and/or sulfidic glass, as a catholyte or anolyte. In the case of a separator, mechanical stability furthermore can advantageously be further improved by way of such blending.

The at least one polymer having a lithium-ion transference number >0.7 and/or the at least one, in particular ceramic and/or glass-like, inorganic ion conductor of the separator and/or of the protective layer, and of the cathode and/or anode, do not necessarily need to be identical.

The cathode, for example, can encompass at least one, in particular ceramic and/or glass-like, inorganic ion conductor, in particular single-ion conductor, or a blend of at least one, in particular ceramic and/or glass-like, inorganic ion conductor, in particular single-ion conductor, for example a lithium argyrodite and/or a sulfidic glass, and at least one polymer having a lithium-ion transference number >0.7, for example a single-ion-conducting polyelectrolyte.

The separator and/or the protective layer can in particular encompass at least one polymer having a lithium-ion transference number >0.7, for example a single-ion-conducting polyelectrolyte, or a blend of at least one polymer having a lithium-ion transference number >0.7, for example a single-ion-conducting polyelectrolyte, and at least one, in particular ceramic and/or glass-like, inorganic ion conductor, in particular single-ion conductor, for example a lithium argyrodite and/or a sulfidic glass and at least one polymer having a lithium-ion transference number >0.7, for example a single-ion-conducting polyelectrolyte. The separator and/or the protective layer can thus advantageously be manufactured in simple fashion as a thin film of <50 μm, for instance by way of a slurry process and/or casting process, and, for example, can be applicable directly onto the cathode or anode. Polymers having a lithium-ion transference number >0.7, for example single-ion-conducting polyelectrolytes, furthermore tend to be softer than inorganic ion conductors such as sulfidic glasses and/or lithium argyrodites, and can therefore tend to implement lower contact resistance values.

In the context of an embodiment, the separator and/or the protective layer is a separator according to the present invention and/or a protective layer according to the present invention. The lithium cell can be in this context, for example, a lithium cell according to the present invention explained previously.

The cathode can in particular encompass a particulate cathode active material. The cathode active material can, for example, encompass or be constituted from a lithium conversion material, i.e., a material that can participate in a conversion reaction with lithium, for instance sulfur-based, or a lithium intercalation material, i.e., a material that can intercalate lithium, for instance based on metal oxide, for example nickel cobalt aluminum oxide (NCA) and/or nickel cobalt manganese oxide (NCM), high-energy nickel cobalt manganese oxide (HE-NCM), lithium manganese oxide (LMO), and/or high-voltage spinels (HV-LMO).

In the context of a special embodiment, the cathode active material encompasses or is constituted from a sulfur-carbon composite, in particular a sulfur-polymer and/or -carbon modification composite. For instance, the cathode active material can encompass or be constituted from a sulfur-polymer composite, for example a composite of an, in particular electrically conductive, polymer with covalently and/or ionically, in particular covalently, bound sulfur. For example, the cathode active material can encompass or be constituted from a sulfur-polyacrylonitrile composite. For instance, the cathode active material can encompass or be constituted from SPAN.

“SPAN” can be understood in particular as a composite or polymer based on polyacrylonitrile (PAN), in particular cyclized polyacrylonitrile (cPAN), having, in particular covalently, bound sulfur, which in particular is obtainable by thermal conversion and/or chemical reaction of polyacrylonitrile in the presence of sulfur. In particular, nitrile groups can react in this context to form a polymer, in particular having a conjugated n system, in which the nitrile groups are converted to mutually contiguous nitrogen-containing rings, in particular six-membered rings, in particular having covalently bound sulfur. SPAN can be manufactured, for instance, by heating polyacrylonitrile (PAN) with an excess of elemental sulfur, in particular to a temperature ≥300° C., for example approximately ≥300° C. to ≤600° C. The sulfur can in particular on the one hand cyclize the polyacrylonitrile (PAN) with formation of hydrogen sulfide (H₂S), and on the other hand can be bound in finely divided fashion in the cyclized matrix, for example with formation of a covalent S—C bond, a cyclized polyacrylonitrile structure having covalent sulfur chains being, for example, formed. SPAN is described in Chem. Mater., 2011, 23, 5024 and J. Mater. Chem., 2012, 22, 23240, J. Electrochem. Soc., 2013, 160 (8) A1170, and in PCT Application No. WO 2013/182360 A1.

When sulfur, for instance SPAN, is used as an active material, the separator and/or the protective layer can additionally take on the function of a diffusion barrier.

The anode can in particular be a lithium metal anode. It is thereby advantageously possible to achieve a particularly high specific energy density. The separator and/or the protective layer and the cathode can, in particular respectively, encompass at least one polymer having a lithium-ion transference number >0.7, in particular >0.8, for example >0.9, for instance a single-ion-conducting polyelectrolyte.

It is also possible, however, to use an anode based on a particulate anode active material. A particularly high rate capability can thereby advantageously be achieved. For instance, the particulate anode active material can encompass or be constituted from a lithium intercalation material, for instance graphite and/or amorphous carbon and/or lithium titanate, and/or a lithium alloy material, for instance silicon and/or tin. The anode active material can be constituted in particular in the form of, for example spherical and/or elongated and/or flake-like and/or fiber-shaped, particles, and can be surrounded by the electrolyte.

In particular if the anode encompasses a particulate anode active material, for example a lithium intercalation material or lithium alloy material, the separator and/or the protective layer and the cathode and the anode can, in particular each or all, encompass at least one polymer having a lithium-ion transference number >0.7, in particular >0.8, for example >0.9, for instance a single-ion-conducting polyelectrolyte.

The at least one polymer having a lithium-ion transference number >0.7, in particular >0.8, for example >0.9, for instance the single-ion-conducting polyelectrolyte, of the separator and/or of the protective layer, and of the cathode and if applicable of the anode, do not necessarily need to be identical, but instead can in particular be adapted to and/or optimized for the respective requirements, for instance in terms of solution behavior, voltage stability, volume work, etc., in the respective utilization range of the cell.

The cathode and/or the anode can furthermore encompass at least one conduction additive. The at least one conduction additive of the cathode and/or of the anode can encompass or be, for example, at least one carbon modification, for instance carbon black and/or graphite. It is thereby possible to constitute or improve a percolating electrically conducting network and thereby to increase electrical conductivity. In particular, the cathode and/or the anode can respectively encompass at least one cathode active material or anode active material, at least one polymer having a lithium-ion transference number >0.7, and/or at least one, in particular ceramic and/or glass-like, inorganic ion conductor, in particular single-ion conductor, and at least one conduction additive.

The separator and/or the protective layer and/or the cathode and/or the anode can furthermore encompass, for example, at least one lithium-ion-conductive polymer, in particular a polyalkylene oxide, for example polyethylene oxide and/or polypropylene oxide, for instance polyethylene oxide, and/or poly(oligoethylene glycol) methacrylate (POEGMA) and/or poly(oligoethylene glycol) acrylate, in particular poly(oligoethylene glycol) methacrylate (POEGMA).

The cathode can furthermore, if applicable, in particular in addition to the at least one single-ion-conducting polyelectrolyte, encompass at least one liquid electrolyte, for instance made of at least one solvent, for example at least one organic carbonate, such as ethylene carbonate (EC) and/or dimethyl carbonate (DMC) and/or diethyl carbonate (DEC), and at least one lithium conducting salt, for example lithium bis(trifluoromethanesulfonyl)imide (LiTFSI), for instance EC:DMC:DEC+LiTFSI, and/or at least one ionic liquid. The addition of a liquid electrolyte and/or an ionic liquid advantageously allows lithium ion conductivity and lithium ion diffusion to be enhanced and lithium ion transport in the cell to be optimized, while the high lithium-ion transference numbers (t+) still remain sufficiently high (close to 1). The separator, in particular according to the present invention, can additionally take on the function of a barrier for the liquid components of the catholyte and/or anolyte. The separator, in particular according to the present invention, can advantageously retain its mechanical properties, in particular the property of suppressing dendrites, and can, for example, experience very little if any dissolution or swelling.

For instance, the cells according to the present invention can be used in a battery for a vehicle, for example for an electrical and/or hybrid vehicle, and/or for a consumer application, for example for a mobile device such as a mobile computer and/or a tablet and/or a smartphone.

With regard to further technical features and advantages of the cells according to the present invention, reference is herewith explicitly made to the explanations in conjunction with the separator according to the present invention, the protective layer according to the present invention, the copolymer according to the present invention, the polymer blend according to the present invention, and the polymer electrolyte according to the present invention, and to the Figures and the description of the Figures.

The invention further relates to a copolymer and/or polymer blend and/or to a polymer electrolyte, in particular for a lithium cell, for example for a lithium-sulfur cell and/or a lithium-ion cell, and/or for a solid-state cell.

The copolymer encompasses in this context, in particular, at least one repeating unit for constituting a polymer having a lithium-ion transference number >0.7, in particular >0.8, for example >0.9, in particular for constituting a single-ion-conducting polyelectrolyte, and at least one mechanically stabilizing repeating unit.

The polymer blend can encompass in particular at least one polymer having a lithium-ion transference number >0.7, in particular >0.8, for example >0.9, in particular at least one single-ion-conducting polyelectrolyte, and at least one mechanically stabilizing polymer.

The polymer electrolyte can at least encompass at least one repeating unit for constituting a polymer having a lithium-ion transference number >0.7, in particular >0.8, for example >0.9, in particular for constituting at least at least one single-ion-conducting polyelectrolyte, and/or at least one polymer having a lithium-ion transference number >0.7, in particular >0.8, for example >0.9, in particular at least one single-ion-conducting polyelectrolyte. If applicable, the polymer electrolyte can furthermore encompass at least one mechanically stabilizing repeating unit and/or at least one mechanically stabilizing polymer. For instance, polyelectrolyte can be based on a copolymer, for example of such a kind, and/or on a polymer blend, for example of such a kind.

The at least one mechanically stabilizing repeating unit can in particular encompass or be at least one styrene-based repeating unit, and/or the at least one mechanically stabilizing polymer can encompass or be a styrene-based polymer.

In the context of a further embodiment, the at least one repeating unit for constituting a polymer having a lithium-ion transference number >0.7, in particular for constituting a single-ion-conducting polyelectrolyte, of the copolymer and/or of the polymer electrolyte encompasses or is a borate-based unit and/or a sulfonic acid-based unit and/or an imide-based, in particular sulfonylimide-based, unit, and or a unit on the basis of lithiated acrylic acid and/or methacrylic acid and/or a perfluoroether-based unit, and/or the at least one polymer having a lithium-ion transference number >0.7, in particular the at least one single-ion-conducting polyelectrolyte, of the polymer blend and/or of the polymer electrolyte encompasses or is a borate-based polyelectrolyte and/or a sulfonic acid-based polyelectrolyte and/or an imide-based, in particular sulfonylimide-based, polyelectrolyte, and or a polyelectrolyte on the basis of lithiated acrylic acid and/or methacrylic acid and/or a perfluoroether-based polymer.

The at least one styrene-based repeating unit and/or the at least one polymer can be obtainable, for example, by polymerization of styrene and/or o-methylstyrene and/or p-methylstyrene and/or m-t-butoxystyrene and/or 2,4-dimethylstyrene and/or m-chlorostyrene and/or p-chlorostyrene and/or 4-carboxystyrene and/or vinylanisole, and/or vinylbenzoic acid and/or vinylaniline and/or vinylnaphthalene and/or analogs.

The at least one repeating unit for constituting a polymer having a lithium-ion transference number >0.7 can be designed in particular for constituting a single-ion-conducting polyelectrolyte. The at least one polymer having a lithium-ion transference number >0.7 can in particular be a single-ion-conducting polyelectrolyte.

The at least one repeating unit for constituting a polymer having a lithium-ion transference number >0.7, in particular >0.9, or the at least one repeating unit for constituting a single-ion-conducting polyelectrolyte, can encompass or be, for example, a borate-based unit and/or a sulfonic acid-based unit and/or an imide-based, in particular sulfonylimide-based, unit, and or a unit on the basis of lithiated acrylic acid and/or methacrylic acid.

The at least one polymer having a lithium-ion transference number >0.7, in particular >0.9, or the at least one single-ion-conducting polyelectrolyte, can encompass or be, for example, a borate-based polyelectrolyte and/or a sulfonic acid-based polyelectrolyte and/or an imide-based, in particular sulfonylimide-based, polyelectrolyte, and or a polyelectrolyte on the basis of lithiated acrylic acid and/or methacrylic acid.

In the context of a further embodiment, the copolymer is a block copolymer. The block copolymer can encompass at least one, in particular single-ion-conducting, block (b-A, for example b-SIC) made of at least one repeating unit for constituting a polymer having a lithium-ion transference number >0.7 (A, for example SIC), and at least one, in particular mechanically stabilizing, block (b-B, for example b-PS) made of at least one mechanically stabilizing, in particular styrene-based, repeating unit.

In the context of a further embodiment the copolymer furthermore encompasses at least one lithium-ion-conductive repeating unit. The at least one lithium-ion-conductive repeating unit can encompass or be an alkylene oxide unit, in particular an ethylene oxide unit (EO) and/or a propylene oxide unit (PO), in particular an ethylene oxide unit (EO), and/or an oligoethylene glycol methacrylate unit (OEGMA) and/or an oligoethylene glycol acrylate unit, in particular an oligoethylene glycol methacrylate unit (OEGMA).

In the context of a further, alternative or additional embodiment, the polymer blend furthermore encompasses at least one lithium-ion-conductive polymer. The at least one lithium-ion-conductive polymer can encompass or be a polyalkylene oxide, for example polyethylene oxide and/or polypropylene oxide, in particular polyethylene oxide, and/or poly(oligoethylene glycol) methacrylate (POEGMA) and/or poly(oligoethylene glycol) acrylate, in particular poly(oligoethylene glycol) methacrylate (POEGMA).

For instance, the block copolymer can furthermore encompass at least one, in particular lithium-ion-conductive, block made of at least one lithium-ion-conductive repeating unit.

For instance, the block copolymer can be a di-block copolymer (b-A-b-B, for example b-SIC-b-PS) or a tri-block copolymer (b-A-b-B-b-A or b-B-b-A-b-B, for example b-SIC-b-PS-b-SIC or b-PS-b-SIC-b-PS) or a multi-block copolymer (b-A-b-C-b-B-b-C-b-A, for example b-SIC-b-OEGMA/EO/PO-b-PS-b-OEGMA/EO/PO-b-SIC).

With regard to further technical features and advantages of the copolymer according to the present invention, the polymer blend according to the present invention, and the polymer electrolyte according to the present invention, reference is herewith explicitly made to the explanations in conjunction with the separator according to the present invention, the protective layer according to the present invention, and the cells according to the present invention, and to the figures and the description of the figures below.

### BRIEF DESCRIPTION OF THE DRAWINGS

Further advantages and advantageous embodiments of the present invention are illustrated in the figures and explained in the description below. Be it noted in this context that the figures are merely descriptive in nature and are not intended to limit the present invention in any way.

FIG. 1 is a schematic cross section through an embodiment of a lithium cell according to the present invention.

FIG. 2 is a graph to illustrate the dependence between a minimally required transference number (t⁺ₘᵢₙ) for a cathodic polymer electrolyte in the context of an assumed ionic conductivity or diffusion coefficient of the cathodic polymer electrolyte in a cell in order to achieve a 1C, 2C, and 3C rate capability for the cell.

### DETAILED DESCRIPTION OF EXAMPLE EMBODIMENTS

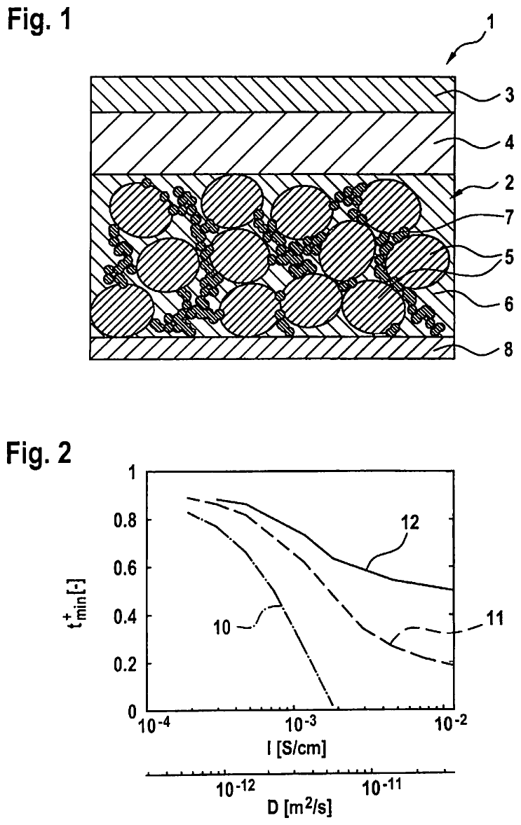

FIG. 1 shows a lithium cell 1, in particular in the form of a solid-state cell, which encompasses a cathode 2 and an anode 3, a separator 4 being disposed between cathode 2 and anode 3. Anode 3 is a lithium metal anode made of metallic lithium. Separator 4 also performs the function of a protective layer with respect to dendrite formation from anode 3.

Separator 4 encompasses in particular at least one polymer having a lithium-ion transference number >0.7. Separator 4 can in particular encompass for that purpose at least one single-ion-conducting polyelectrolyte. For instance, separator 4 can encompass a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid. Separator 4 can furthermore encompass at least one, in particular ceramic and/or glass-like, inorganic ion conductor, in particular single-ion conductor, having a lithium-ion transference number >0.7, for example a lithium argyrodite and/or a sulfidic glass (not depicted).

Cathode 2 encompasses an, in particular particulate, cathode active material 5, for example based on metal oxide such as nickel cobalt aluminum oxide (NCA), nickel cobalt manganese oxide (NCM), high-energy nickel cobalt manganese oxide (HE-NCM), lithium manganese oxide (LMO), and/or high-voltage spinels (HV-LMO), and/or based on sulfur, and, in particular constituting catholyte 6, at least one polymer having a lithium-ion transference number >0.7 and/or at least one, in particular ceramic and/or glass-like, inorganic ion conductor, in particular single-ion conductor, having a lithium-ion transference number >0.7. Cathode 2 can in particular encompass for this purpose at least one single-ion-conducting polyelectrolyte and/or at least one lithium argyrodite and/or sulfidic glass. For instance, cathode 2 can encompass a borate-based polyelectrolyte and/or a sulfonic acid-based polyelectrolyte and/or an imide-based, in particular sulfonylimide-based, polyelectrolyte, and/or a polyelectrolyte on the basis of lithiated acrylic acid and/or methacrylic acid. Cathode 2 furthermore encompasses a conduction additive 7, for example carbon black and/or graphite, to improve the electrical conductivity of cathode 2.

The at least one polymer having a lithium-ion transference number >0.7, in particular the at least one single-ion-conducting polyelectrolyte, of separator 4, and the at least one polymer having a lithium-ion transference number >0.7, in particular the at least one single-ion-conducting polyelectrolyte, of cathode 2 can be different or, if applicable, also at least similar.

FIG. 1 furthermore shows that cathode 2 is equipped with a current collector 8.

In the context of a special example embodiment, separator 4 encompasses a copolymer and/or a polymer blend, the copolymer encompassing at least one repeating unit for constituting a polymer having a lithium-ion transference number >0.7, in particular for constituting a single-ion-conducting polyelectrolyte, and at least one mechanically stabilizing repeating unit, and/or the polymer blend, encompassing at least one polymer having a lithium-ion transference number >0.7, in particular at least one single-ion-conducting polyelectrolyte, and at least one mechanically stabilizing polymer. The at least one mechanically stabilizing repeating unit can encompass or be at least one styrene-based repeating unit, and/or the at least one mechanically stabilizing polymer can encompass or be at least one styrene-based polymer. In particular, the at least one polymer having a lithium-ion transference number >0.7 of separator 4 and the at least one polymer having a lithium-ion transference number >0.7 of cathode 2 can differ from one another at least in that the at least one polymer having a lithium-ion transference number >0.7 of cathode 2 is devoid of a mechanically stabilizing, for example styrene-based, repeating unit, and/or devoid of a mechanically stabilizing, in particular styrene-based, polymer. The at least one repeating unit for constituting a polymer having a lithium-ion transference number >0.7, and/or the at least one polymer having a lithium-ion transference number >0.7, of separator 4, and the at least one polymer having a lithium-ion transference number >0.7 of cathode 2, can otherwise likewise be different or, in particular, can also be at least similar to one another or, if applicable, can even be identical.

FIG. 2 illustrates the results of calculations in which the minimally required lithium-ion transference numbers t⁺ₘᵢₙ, required in order to implement a charging operation at a constant C rate SOC=0% to SOC=75%, of a cathodic polymer electrolyte having an assumed conductivity or diffusion coefficient for a cell have been calculated. The basis here was a cell having a 10-μm thick separator which, constituting a conventional polymer electrolyte, for instance PEO/LiTFSI, is embodied with a conductivity of 4 e⁻⁴ S/cm, a salt diffusion coefficient of 1 e⁻¹² m²/s, and a lithium-ion transference number t⁺ of 0.25, and whose transport properties are not varied, and having a cathode that has a charge of 4 mAh/cm² and likewise contains a polymer electrolyte, for instance PEO/LiTFSI, whose transport properties have, however, been varied. The transport properties of the polymer electrolyte of the cathode which were varied were in particular the conductivity I and the diffusion coefficient D of a conducting salt in the polymer electrolyte of the cathode.

FIG. 2 depicts the results for simulated charging operations at a constant C rate, namely for 1C in curve 10, for 2C in curve 11, and for 3C in curve 12. In FIG. 2, curve 12 at approximately 1 e⁻² S/cm can be interpreted to mean that for a constant current charge 3C, a transference number t⁺>0.5 is required. What was used for calculation of the graph depicted in FIG. 2, however, was a PEO-based polymer electrolyte, having a lithium-ion transference number t⁺ of 0.25, as a separator, which results in an additional concentration polarization and thus increases the demand in terms of the transference number of the polymer electrolyte of the cathode (catholyte). When a polymer having a lithium-ion transference number >0.7, and in particular a single-ion-conducting polyelectrolyte, for example having a lithium-ion transference number >0.8 or >0.9, is used as a separator and/or protective layer, the demands in terms of the minimally required lithium-ion transference numbers of the catholyte advantageously decrease as compared with what is depicted in FIG. 2. It is thus apparent, advantageously, that, for instance, a 3C charging operation can already be achieved with a catholyte conductivity of 1 e⁻³ S/cm and a lithium-ion transference number >0.7, for instance already for a lithium-ion transference number t⁺=0.5, in the catholyte (not depicted in the Figures).

1-20. (canceled)

21. A separator and/or protective layer for a lithium cell, comprising:
at least one of: (i) a copolymer encompassing at least one repeating unit for constituting a polymer having a lithium-ion transference number >0.7 and at least one mechanically stabilizing repeating unit, and (ii) a polymer blend encompassing at least one polymer having a lithium-ion transference number >0.7 and at least one mechanically stabilizing polymer.

22. The separator and/or protective layer as recited in claim 21, wherein at least one of: (i) the at least one mechanically stabilizing repeating unit encompasses at least one styrene-based repeating unit, and (ii) the at least one mechanically stabilizing polymer encompasses at least one styrene-based polymer.

23. The separator and/or protective layer as recited in claim 1, wherein at least one of: (i) the at least one repeating unit for constituting a polymer having a lithium-ion transference number >0.7 is designed to constitute a single-ion-conducting polyelectrolyte, and (ii) the at least one polymer having a lithium-ion transference number >0.7 encompasses a single-ion-conducting polyelectrolyte.

24. The separator and/or protective layer as recited in claim 23, wherein one of: (i) the at least one repeating unit for constituting a polymer having a lithium-ion transference number >0.7, or (ii) the at least one repeating unit for constituting a single-ion-conducting polyelectrolyte, encompasses at least one of a borate-based unit, a sulfonic acid-based unit, a sulfonylimide-based unit, a unit based on lithiated acrylic acid, and a unit based on methacrylic acid.

25. The separator and/or protective layer as recited in claim 23, wherein one of: (i) the at least one polymer having a lithium-ion transference number >0.7, or (ii) the at least one single-ion-conducting polyelectrolyte, encompasses at least one of a borate-based polyelectrolyte, a sulfonic acid-based polyelectrolyte, a sulfonylimide-based polyelectrolyte, a polyelectrolyte based on lithiated acrylic acid, a polyelectrolyte based on methacrylic acid.

26. The separator and/or protective layer as recited in claim 21, wherein the copolymer is a block copolymer, the block copolymer encompassing at least one block made of at least one repeating unit for constituting a single-ion-conducting polyelectrolyte, and at least one block made of at least one mechanically stabilizing styrene-based, repeating unit.

27. The separator and/or protective layer as recited in claim 21, wherein at least one of: (i) the copolymer encompasses at least one lithium-ion-conductive repeating unit, and (ii) the polymer blend encompasses at least one lithium-ion-conductive polymer.

28. The separator and/or protective layer as recited in claim 27, wherein the at least one lithium-ion-conductive repeating unit is at least one of an ethylene oxide unit, an oligoethylene glycol methacrylate unit, and an oligoethylene glycol methacrylate unit.

29. The The separator and/or protective layer as recited in claim 27, wherein the at least one lithium-ion-conductive polymer is at least one of polyethylene oxide, poly(oligoethylene glycol) methacrylate, and poly(oligoethylene glycol) methacrylate.

30. The separator and/or protective layer as recited in claim 26, wherein the block copolymer is one of a di-block copolymer, a tri-block copolymer, or multi-block copolymer.

31. The separator and/or protective layer as recited in claim 21, wherein the separator and/or the protective layer furthermore encompasses at least one inorganic single-ion conductor, the at least one inorganic single-ion conductor being at least one of a lithium argyrodite, and a sulfidic glass.

32. A lithium cell, comprising:
a separator and/or a protective layer including at least one of: (i) a copolymer encompassing at least one repeating unit for constituting a polymer having a lithium-ion transference number >0.7 and at least one mechanically stabilizing repeating unit, and (ii) a polymer blend encompassing at least one polymer having a lithium-ion transference number >0.7 and at least one mechanically stabilizing polymer.

33. A lithium cell, comprising:
a cathode;
an anode; and
a separator and/or a protective layer disposed between the cathode and the anode, the separator and/or the protective layer encompassing at least one of: (i) at least one polymer having a lithium-ion transference number >0.7, and (ii) at least one ceramic and/or glass-like, inorganic single-ion conductor having a lithium-ion transference number >0.7;
wherein at least one of: (A) the cathode encompasses at least one of: (i) at least one polymer having a lithium-ion transference number >0.7, and (ii) at least one ceramic and/or glass-like, inorganic single-ion conductor, and (B) the anode encompasses at least one of (i) polymer having a lithium-ion transference number >0.7 and (ii) at least one ceramic and/or glass-like, inorganic single-ion conductor.

34. The lithium cell as recited in claim 33, wherein at least one of: (i) the at least one inorganic single-ion conductor of the separator and/or of the protective layer is at least one of a lithium argyrodite, and a sulfidic glass, (ii) the at least one inorganic single-ion conductor of the cathode is at least one of a lithium argyrodite, a sulfidic glass, and (iii) the at least one inorganic single-ion conductor of the anode being at least one of a lithium argyrodite and a sulfidic glass.

35. The lithium cell as recited in claim 34, wherein the at least one polymer, having a lithium-ion transference number >0.7, of the separator and/or of the protective layer encompasses a single-ion-conducting polyelectrolyte, and wherein at least one of: (i) the at least one polymer, having a lithium-ion transference number >0.7 of the cathode encompasses a single-ion-conducting polyelectrolyte, and (ii) the at least one polymer, having a lithium-ion transference number >0.7 of the anode encompasses a single-ion-conducting polyelectrolyte.

36. The lithium cell as recited in claim 35, wherein the at least one polymer having a lithium-ion transference number >0.7 or the at least one single-ion-conducting polyelectrolyte, of the separator and/or of the protective layer encompasses at least one of a borate-based polyelectrolyte, a sulfonic acid-based polyelectrolyte, a sulfonylimide-based polyelectrolyte, a polyelectrolyte based on lithiated acrylic acid, and a polyelectrolyte based on methacrylic acid, and wherein at least one of: (i) the at least one polymer, having a lithium-ion transference number >0.7, or the at least one single-ion-conducting polyelectrolyte, of the cathode encompasses one of a borate-based polyelectrolyte, a sulfonic acid-based polyelectrolyte, a sulfonylimide-based polyelectrolyte, a polyelectrolyte based on lithiated acrylic acid, and a polyelectrolyte based on methacrylic acid, and (ii) the at least one polymer having a lithium-ion transference number >0.7, or the at least one single-ion-conducting polyelectrolyte, of the anode encompasses at least one of a borate-based polyelectrolyte, a sulfonic acid-based polyelectrolyte. a sulfonylimide-based polyelectrolyte, a polyelectrolyte based on lithiated acrylic acid, and a polyelectrolyte based on methacrylic acid.

37. The lithium cell as recited in claim 33, wherein the separator and/or the protective layer encompasses a blend of at least one polymer having a lithium-ion transference number >0.7, the blend of the separator and/or protective layer including a single-ion-conducting polyelectrolyte, and at least one inorganic ion conductor, the at least one inorganic ion conductor including at least one of a lithium argyrodite and a sulfidic glass; and wherein at least one of: (i) the cathode encompasses a blend of at least one polymer having a lithium-ion transference number >0.7, the blend of the cathode including a single-ion-conducting polyelectrolyte, and at least one inorganic ion conductor, the at least one inorganic ion conductor including at least one of a lithium argyrodite and a sulfidic glass, and (ii) the anode encompasses a blend of at least one polymer having a lithium-ion transference number >0.7, the blend of the anode including at least one of a single-ion-conducting polyelectrolyte, and at least one inorganic ion conductor, the at least one inorganic ion conductor including at least one of a lithium argyrodite and a sulfidic glass.

38. The lithium cell as recited in claim 33, wherein one of: (i) the anode is a lithium metal anode, and the separator and/or the protective layer and the cathode encompass at least one single-ion-conducting polyelectrolyte, or (ii) the anode encompasses a particulate anode active material, and the separator and/or the protective layer, the cathode, and the anode encompass at least one single-ion-conducting polyelectrolyte.

39. A copolymer, the copolymer encompassing at least one repeating unit for constituting a polymer having a lithium-ion transference number >0.7, the at least one repeating unit including at least one of: a borate-based unit, a sulfonic acid-based unit, a sulfonylimide-based unit, a unit based on lithiated acrylic acid, a unit based on methacrylic acid, and a perfluoroether-based unit, and at least one styrene-based repeating unit.

40. A polymer blend, the polymer blend encompassing at least one polymer having a lithium-ion transference number >0.7, the at least one polymer including at least one of a borate-based polyelectrolyte, a sulfonic acid-based polyelectrolyte, a sulfonylimide-based polyelectrolyte, a polyelectrolyte based on lithiated acrylic acid, a polyelectrolyte based methacrylic acid, and a perfluoroether-based polymer, and at least one styrene-based polymer.

41. The copolymer as recited in claim 39, wherein the copolymer is a block copolymer, the block copolymer encompassing at least one block made of at least one repeating unit for constituting a polymer having a lithium-ion transference number >0.7 and at least one block made of at least one styrene-based, repeating unit.

42. The copolymer as recited in claim 39, wherein the copolymer further encompasses at least one lithium-ion-conductive repeating unit, the at least one lithium-ion-conductive repeating unit being at least one of an alkylene oxide unit, an ethylene oxide unit, an oligoethylene glycol methacrylate unit, and an oligoethylene glycol acrylate unit.

43. The polymer blend as recited in claim 40, wherein the polymer blend further encompasses at least one lithium-ion-conductive polymer, the at least one lithium-ion-conductive polymer encompassing at least one of polyethylene oxide, poly(oligoethylene glycol) methacrylate, and poly(oligoethylene glycol) acrylate.

44. The copolymer as recited in claim 41, wherein the block copolymer further encompasses at least one block made of at least one lithium-ion-conductive repeating unit.
